(19) United States
(12) Patent Application Publication
(10) Pub. No.: US 2025/0324331 A1
(43) Pub. Date: Oct. 16, 2025

(54) METHOD, APPARATUS AND COMPUTER PROGRAM

(71) Applicant: Nokia Technologies Oy, Espoo (FI)

(72) Inventors: Panagiotis SPAPIS, Munich (DE); Halit Murat GÜRSU, Munich (DE); Alperen GUNDOGAN, Munich (DE); Umur KARABULUT, Munich (DE); Ahmad AWADA, Munich (DE)

(21) Appl. No.: 18/865,591

(22) PCT Filed: May 16, 2023
(86) PCT No.: PCT/FI2023/050274

§ 371 Date: Nov. 13, 2024

(30) Foreign Application Priority Data
May 17, 2022 (FI) 20225434

(51) Int. Cl. H04W 36/08; H04W 36/36

(52) U.S. Cl. CPC H04W 36/08; H04W 36/362

(57) ABSTRACT

There is provided an apparatus comprising means for: receiving, at a target cell, information indicating a current serving cell of a user equipment; and performing, by the target cell, handover of the user equipment from the current serving cell to the target cell, wherein the handover is based on the information indicating the current serving cell.

### FIELD

The present application relates to a method, apparatus, and computer program and in particular but not exclusively to informing a target cell of a current serving cell of a user equipment for performing handover.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the communication system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). Other examples of communication systems are the long-term evolution (LTE) of the Universal Mobile Telecommunications System (UMTS) radio-access technology and so-called 5G or New Radio (NR) networks. NR is being standardized by the 3rd Generation Partnership Project (3GPP).

### SUMMARY

According to an aspect, there is provided an apparatus comprising means for: receiving, at a target cell, information indicating a current serving cell of a user equipment; and performing, by the target cell, handover of the user equipment from the current serving cell to the target cell, wherein the handover is based on the information indicating the current serving cell.

The means may be for: receiving, at the target cell from an initial source cell serving the user equipment, a conditional handover configuration for the user equipment; wherein performing the handover is further based on the conditional handover configuration.

The means may be for: upon completion of the handover, sending, to one or more further cells, information indicating that the target cell is the new current serving cell of the user equipment.

Performing the handover may comprise: receiving, from the user equipment, a message comprising a physical random access channel preamble, the physical random access channel preamble being based on the conditional handover configuration; in response to the physical random access channel preamble, sending, to the user equipment, a message comprising a random access channel response; and receiving, from the user equipment, a radio resource control reconfiguration complete message.

The information indicating the current serving cell of the user equipment may be received from one of: the user equipment during the handover of the user equipment from the current serving cell to the target cell; the current serving cell during the handover of the user equipment from the current serving cell to the target cell; and the initial source cell during the handover of the user equipment from the current serving cell to the target cell.

Performing the handover based on the information indicating the current serving cell may comprise: receiving, from the current serving cell and based on the information indicating the current serving cell, status information associated with the user equipment and/or data buffered at the current serving cell for delivery to the user equipment.

According to an aspect, there is provided an apparatus comprising means for: sending, from a user equipment to a target cell, information indicating a current serving cell of the user equipment when the user equipment performs handover from the current serving cell to the target cell; and performing, at the user equipment, handover of the user equipment from the current serving cell to the target cell, wherein the handover is based on the information indicating the current serving cell.

The means may be for: receiving, at the user equipment from an initial source cell serving the user equipment, at least one conditional handover configuration for the user equipment; wherein performing the handover is further based on the conditional handover configuration.

Performing the handover may comprise: determining, at the user equipment and based on the conditional handover configuration, that at least one condition associated with the target cell is met; responsive to the determining, sending, to the target cell, a message comprising a physical random access channel preamble, the physical random access channel preamble being based on the conditional handover configuration; receiving, from the target cell, a message comprising a random access channel response; and responsive to receiving the message comprising the random access channel response, sending, to the target cell a radio resource control reconfiguration complete message.

The information indicating the current serving cell of the user equipment may be comprised in a radio resource control reconfiguration complete message sent to the target cell when performing the handover.

The means may be for: storing a radio resource control configuration of the initial source cell; and applying a change in radio resource control configuration on top of the radio resource control configuration of the initial source cell when handover of the user equipment is performed.

The means may be for: receiving, from the current serving cell, a message comprising an indication that one or more further target cells are no longer available for conditional handover of the user equipment; and updating a conditional handover configuration of the user equipment based on the received message.

According to an aspect, there is provided an apparatus comprising means for: sending, to a target cell, information indicating a current serving cell of the user equipment when the user equipment performs handover to the target cell from the current serving cell.

The apparatus may comprise the current serving cell, and wherein the means may be further configured for: receiving, from the target cell, an indication that handover has been performed for the user equipment to the target cell; and responsive to receiving the indication, sending, to the target cell, status information associated with the user equipment and/or data buffered at the current serving cell for delivery to the user equipment.

The means may be for: receiving, from an initial source cell, information indicating that the one or more further target cells are no longer available for conditional handover of the user equipment; and sending, to the user equipment, a message comprising an indication that the one or more further target cells are no longer available for conditional handover of the user equipment.

The apparatus may comprise an initial source cell; and wherein the means may be further for: sending, to the target cell, a conditional handover configuration for the user equipment.

The means may be for: receiving, from the current serving cell, information indicating that the user equipment has been handed over to the current serving cell; storing, at the initial source cell and based on the received information, the information identifying the current serving cell of the user equipment; and sending, to the target cell, the information indicating the current serving cell of the user equipment.

The means may be for: receiving, from one or more further target cells, information indicating that the one or more further target cells are no longer available for conditional handover of the user equipment; and sending, to the current serving cell, a message comprising an indication that one or more further target cells are no longer available for conditional handover of the user equipment.

The information indicating the current serving cell of the user equipment may comprise a physical cell identity of the current serving cell or a global cell identity of the current serving cell.

According to an aspect, there is provided an apparatus comprising at least one processor and at least one memory including a computer program code, the at least one memory and computer program code configured to, with the at least one processor, cause the apparatus at least to: receive information indicating a current serving cell of a user equipment; and perform handover of the user equipment from the current serving cell to a target cell, wherein the handover is based on the information indicating the current serving cell.

The at least one memory and at least one processor may be configured to cause the apparatus to: receive, from an initial source cell serving the user equipment, a conditional handover configuration for the user equipment; wherein the at least one memory and at least one processor may be configured to cause the apparatus to perform the handover based on the conditional handover configuration.

The at least one memory and at least one processor may be configured to cause the apparatus to: upon completion of the handover, send, to one or more further cells, information indicating that the target cell is the new current serving cell of the user equipment.

The at least one memory and at least one processor may be configured to cause the apparatus to perform the handover by causing the apparatus to at least: receive, from the user equipment, a message comprising a physical random access channel preamble, the physical random access channel preamble being based on the conditional handover configuration; in response to the physical random access channel preamble, send, to the user equipment, a message comprising a random access channel response; and receive, from the user equipment, a radio resource control reconfiguration complete message.

The information indicating the current serving cell of the user equipment may be received from one of: the user equipment during the handover of the user equipment from the current serving cell to the target cell; the current serving cell during the handover of the user equipment from the current serving cell to the target cell; and the initial source cell during the handover of the user equipment from the current serving cell to the target cell.

The at least one memory and at least one processor may be configured to cause the apparatus to: receive, from the current serving cell and based on the information indicating the current serving cell, status information associated with the user equipment and/or data buffered at the current serving cell for delivery to the user equipment.

According to an aspect, there is provided an apparatus comprising at least one processor and at least one memory including a computer program code, the at least one memory and computer program code configured to, with the at least one processor, cause the apparatus at least to: send, to a target cell, information indicating a current serving cell of a user equipment when the user equipment performs handover from the current serving cell to the target cell; and perform handover of the user equipment from the current serving cell to the target cell, wherein the handover is based on the information indicating the current serving cell.

The at least one memory and at least one processor may be configured to cause the apparatus to: receive, from an initial source cell serving the user equipment, at least one conditional handover configuration for the user equipment; wherein the at least one memory and at least one processor may be configured to cause the apparatus to perform the handover based on the conditional handover configuration.

The at least one memory and at least one processor may be configured to cause the apparatus to perform the handover by causing the apparatus to at least: determine, based on the conditional handover configuration, that at least one condition associated with the target cell is met; responsive to the determining, send, to the target cell, a message comprising a physical random access channel preamble, the physical random access channel preamble being based on the conditional handover configuration; receive, from the target cell, a message comprising a random access channel response; and responsive to receiving the message comprising the random access channel response, send, to the target cell a radio resource control reconfiguration complete message.

The information indicating the current serving cell of the user equipment may be comprised in a radio resource control reconfiguration complete message sent to the target cell when performing the handover.

The at least one memory and at least one processor may be configured to cause the apparatus to: store a radio resource control configuration of the initial source cell; and apply a change in radio resource control configuration on top of the radio resource control configuration of the initial source cell when handover of the user equipment is performed.

The at least one memory and at least one processor may be configured to cause the apparatus to: receive, from the current serving cell, a message comprising an indication that one or more further target cells are no longer available for conditional handover of the user equipment; and update a conditional handover configuration of the user equipment based on the received message.

According to an aspect, there is provided an apparatus comprising at least one processor and at least one memory including a computer program code, the at least one memory and computer program code configured to, with the at least one processor, cause the apparatus at least to: send, to a target cell, information indicating a current serving cell of the user equipment when the user equipment performs handover to the target cell from the current serving cell.

The apparatus may comprise the current serving cell, and wherein the at least one memory and at least one processor may be configured to cause the apparatus to: receive, from the target cell, an indication that handover has been performed for the user equipment to the target cell; and responsive to receiving the indication, send, to the target cell, status information associated with the user equipment and/or data buffered at the current serving cell for delivery to the user equipment.

The at least one memory and at least one processor may be configured to cause the apparatus to: receive, from an initial source cell, information indicating that the one or more further target cells are no longer available for conditional handover of the user equipment; and send, to the user equipment, a message comprising an indication that the one or more further target cells are no longer available for conditional handover of the user equipment.

The apparatus may comprise an initial source cell; and the at least one memory and at least one processor may be configured to cause the apparatus to: send, to the target cell, a conditional handover configuration for the user equipment.

The at least one memory and at least one processor may be configured to cause the apparatus to: receive, from the current serving cell, information indicating that the user equipment has been handed over to the current serving cell; store, based on the received information, the information identifying the current serving cell of the user equipment; and send, to the target cell, the information indicating the current serving cell of the user equipment.

The at least one memory and at least one processor may be configured to cause the apparatus to: receive, from one or more further target cells, information indicating that the one or more further target cells are no longer available for conditional handover of the user equipment; and send, to the current serving cell, a message comprising an indication that one or more further target cells are no longer available for conditional handover of the user equipment.

The information indicating the current serving cell of the user equipment may comprise a physical cell identity of the current serving cell or a global cell identity of the current serving cell.

According to an aspect, there is provided a method comprising: receiving, at a target cell, information indicating a current serving cell of a user equipment; and performing, by the target cell, handover of the user equipment from the current serving cell to the target cell, wherein the handover is based on the information indicating the current serving cell.

The method may comprise: receiving, at the target cell from an initial source cell serving the user equipment, a conditional handover configuration for the user equipment; wherein performing the handover is further based on the conditional handover configuration.

The method may comprise: upon completion of the handover, sending, to one or more further cells, information indicating that the target cell is the new current serving cell of the user equipment.

Performing the handover may comprise: receiving, from the user equipment, a message comprising a physical random access channel preamble, the physical random access channel preamble being based on the conditional handover configuration; in response to the physical random access channel preamble, sending, to the user equipment, a message comprising a random access channel response; and receiving, from the user equipment, a radio resource control reconfiguration complete message.

The information indicating the current serving cell of the user equipment may be received from one of: the user equipment during the handover of the user equipment from the current serving cell to the target cell; the current serving cell during the handover of the user equipment from the current serving cell to the target cell; and the initial source cell during the handover of the user equipment from the current serving cell to the target cell.

Performing the handover based on the information indicating the current serving cell may comprise: receiving, from the current serving cell and based on the information indicating the current serving cell, status information associated with the user equipment and/or data buffered at the current serving cell for delivery to the user equipment.

According to an aspect, there is provided a method comprising: sending, from a user equipment to a target cell, information indicating a current serving cell of the user equipment when the user equipment performs handover from the current serving cell to the target cell; and performing, at the user equipment, handover of the user equipment from the current serving cell to the target cell, wherein the handover is based on the information indicating the current serving cell.

The method may comprise: receiving, at the user equipment from an initial source cell serving the user equipment, at least one conditional handover configuration for the user equipment; wherein performing the handover is further based on the conditional handover configuration.

Performing the handover may comprise: determining, at the user equipment and based on the conditional handover configuration, that at least one condition associated with the target cell is met; responsive to the determining, sending, to the target cell, a message comprising a physical random access channel preamble, the physical random access channel preamble being based on the conditional handover configuration; receiving, from the target cell, a message comprising a random access channel response; and responsive to receiving the message comprising the random access channel response, sending, to the target cell a radio resource control reconfiguration complete message.

The information indicating the current serving cell of the user equipment may be comprised in a radio resource control reconfiguration complete message sent to the target cell when performing the handover.

The method may comprise: storing a radio resource control configuration of the initial source cell; and applying a change in radio resource control configuration on top of the radio resource control configuration of the initial source cell when handover of the user equipment is performed.

The method may comprise: receiving, from the current serving cell, a message comprising an indication that one or more further target cells are no longer available for conditional handover of the user equipment; and updating a conditional handover configuration of the user equipment based on the received message.

According to an aspect, there is provided a method comprising: sending, to a target cell, information indicating a current serving cell of the user equipment when the user equipment performs handover to the target cell from the current serving cell.

The method may be performed at the current serving cell, and the method may comprise: receiving, from the target cell, an indication that handover has been performed for the user equipment to the target cell; and responsive to receiving the indication, sending, to the target cell, status information associated with the user equipment and/or data buffered at the current serving cell for delivery to the user equipment.

The method may comprise: receiving, from an initial source cell, information indicating that the one or more further target cells are no longer available for conditional handover of the user equipment; and sending, to the user equipment, a message comprising an indication that the one or more further target cells are no longer available for conditional handover of the user equipment.

The method may be performed at initial source cell; and the method may comprise: sending, to the target cell, a conditional handover configuration for the user equipment.

The method may comprise: receiving, from the current serving cell, information indicating that the user equipment has been handed over to the current serving cell; storing, at the initial source cell and based on the received information, the information identifying the current serving cell of the user equipment; and sending, to the target cell, the information indicating the current serving cell of the user equipment.

The method may comprise: receiving, from one or more further target cells, information indicating that the one or more further target cells are no longer available for conditional handover of the user equipment; and sending, to the current serving cell, a message comprising an indication that one or more further target cells are no longer available for conditional handover of the user equipment.

The information indicating the current serving cell of the user equipment may comprise a physical cell identity of the current serving cell or a global cell identity of the current serving cell.

According to an aspect, there is provided a computer readable medium comprising program instructions for causing an apparatus to perform at least the following: receiving, at a target cell, information indicating a current serving cell of a user equipment; and performing, by the target cell, handover of the user equipment from the current serving cell to the target cell, wherein the handover is based on the information indicating the current serving cell.

The computer readable medium comprising program instructions may be for causing the apparatus to perform: receiving, at the target cell from an initial source cell serving the user equipment, a conditional handover configuration for the user equipment; wherein performing the handover is further based on the conditional handover configuration.

The computer readable medium comprising program instructions may be for causing the apparatus to perform: upon completion of the handover, sending, to one or more further cells, information indicating that the target cell is the new current serving cell of the user equipment.

Performing the handover may comprise: receiving, from the user equipment, a message comprising a physical random access channel preamble, the physical random access channel preamble being based on the conditional handover configuration; in response to the physical random access channel preamble, sending, to the user equipment, a message comprising a random access channel response; and receiving, from the user equipment, a radio resource control reconfiguration complete message.

The information indicating the current serving cell of the user equipment may be received from one of: the user equipment during the handover of the user equipment from the current serving cell to the target cell; the current serving cell during the handover of the user equipment from the current serving cell to the target cell; and the initial source cell during the handover of the user equipment from the current serving cell to the target cell.

Performing the handover based on the information indicating the current serving cell may comprise: receiving, from the current serving cell and based on the information indicating the current serving cell, status information associated with the user equipment and/or data buffered at the current serving cell for delivery to the user equipment.

According to an aspect, there is provided a computer readable medium comprising program instructions for causing an apparatus to perform at least the following: sending, from a user equipment to a target cell, information indicating a current serving cell of the user equipment when the user equipment performs handover from the current serving cell to the target cell; and performing, at the user equipment, handover of the user equipment from the current serving cell to the target cell, wherein the handover is based on the information indicating the current serving cell.

The computer readable medium comprising program instructions may be for causing the apparatus to perform: receiving, at the user equipment from an initial source cell serving the user equipment, at least one conditional handover configuration for the user equipment; wherein performing the handover is further based on the conditional handover configuration.

Performing the handover may comprise: determining, at the user equipment and based on the conditional handover configuration, that at least one condition associated with the target cell is met; responsive to the determining, sending, to the target cell, a message comprising a physical random access channel preamble, the physical random access channel preamble being based on the conditional handover configuration; receiving, from the target cell, a message comprising a random access channel response; and responsive to receiving the message comprising the random access channel response, sending, to the target cell a radio resource control reconfiguration complete message.

The information indicating the current serving cell of the user equipment may be comprised in a radio resource control reconfiguration complete message sent to the target cell when performing the handover.

The computer readable medium comprising program instructions may be for causing the apparatus to perform: storing a radio resource control configuration of the initial source cell; and applying a change in radio resource control configuration on top of the radio resource control configuration of the initial source cell when handover of the user equipment is performed.

The computer readable medium comprising program instructions may be for causing the apparatus to perform: receiving, from the current serving cell, a message comprising an indication that one or more further target cells are no longer available for conditional handover of the user equipment; and updating a conditional handover configuration of the user equipment based on the received message.

According to an aspect, there is provided a computer readable medium comprising program instructions for causing an apparatus to perform at least the following: sending, to a target cell, information indicating a current serving cell of the user equipment when the user equipment performs handover to the target cell from the current serving cell.

The apparatus may comprise the current serving cell, and the computer readable medium comprising program instructions may be for causing the apparatus to perform: receiving, from the target cell, an indication that handover has been performed for the user equipment to the target cell; and responsive to receiving the indication, sending, to the target cell, status information associated with the user equipment and/or data buffered at the current serving cell for delivery to the user equipment.

The computer readable medium comprising program instructions may be for causing the apparatus to perform: receiving, from an initial source cell, information indicating that the one or more further target cells are no longer available for conditional handover of the user equipment; and sending, to the user equipment, a message comprising an indication that the one or more further target cells are no longer available for conditional handover of the user equipment.

The apparatus may comprise an initial source cell; and the computer readable medium comprising program instructions may be for causing the apparatus to perform: sending, to the target cell, a conditional handover configuration for the user equipment.

The computer readable medium comprising program instructions may be for causing the apparatus to perform: receiving, from the current serving cell, information indicating that the user equipment has been handed over to the current serving cell; storing, at the initial source cell and based on the received information, the information identifying the current serving cell of the user equipment; and sending, to the target cell, the information indicating the current serving cell of the user equipment.

The computer readable medium comprising program instructions may be for causing the apparatus to perform: receiving, from one or more further target cells, information indicating that the one or more further target cells are no longer available for conditional handover of the user equipment; and sending, to the current serving cell, a message comprising an indication that one or more further target cells are no longer available for conditional handover of the user equipment.

The information indicating the current serving cell of the user equipment may comprise a physical cell identity of the current serving cell or a global cell identity of the current serving cell.

According to an aspect, there is provided a non-transitory computer readable medium comprising program instructions for causing an apparatus to perform at least the method according to any of the preceding aspects.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a representation of a network system according to some example embodiments;

FIG. 2 shows a representation of a control apparatus according to some example embodiments;

FIG. 3 shows a representation of an apparatus according to some example embodiments;

FIG. 4 shows a signalling exchange according to some examples;

FIG. 5 shows methods according to some examples; and

FIGS. 6 to 9 show various signalling exchanges according to some examples.

### DETAILED DESCRIPTION

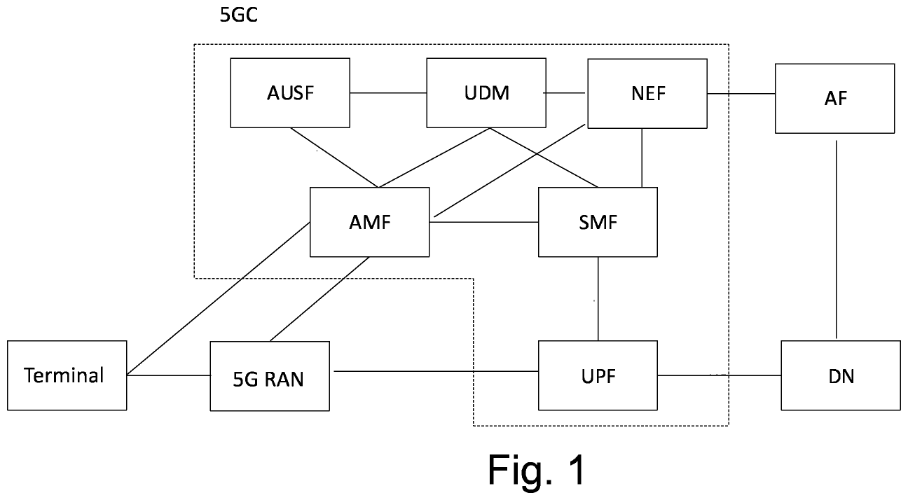

In the following certain embodiments are explained with reference to mobile communication devices capable of communication via a wireless cellular system and mobile communication systems serving such mobile communication devices. Before explaining in detail the exemplifying embodiments, certain general principles of a wireless communication system, access systems thereof, and mobile communication devices are briefly explained with reference to FIGS. 1, 2 and 3 to assist in understanding the technology underlying the described examples.

FIG. 1 shows a schematic representation of a 5G system (5GS). The 5GS may be comprised by a terminal or user equipment (UE), a 5G radio access network (5GRAN) or next generation radio access network (NG-RAN), a 5G core network (5GC), one or more application function (AF) and one or more data networks (DN).

The 5G-RAN may comprise one or more gNodeB (GNB) or one or more gNodeB (GNB) distributed unit functions connected to one or more gNodeB (GNB) centralized unit functions. The 5GC may comprise the following entities: Network Slice Selection Function (NSSF); Network Exposure Function; Network Repository Function (NRF); Policy Control Function (PCF); Unified Data Management (UDM); Application Function (AF); Authentication Server Function (AUSF); an Access and Mobility Management Function (AMF); and Session Management Function (SMF).

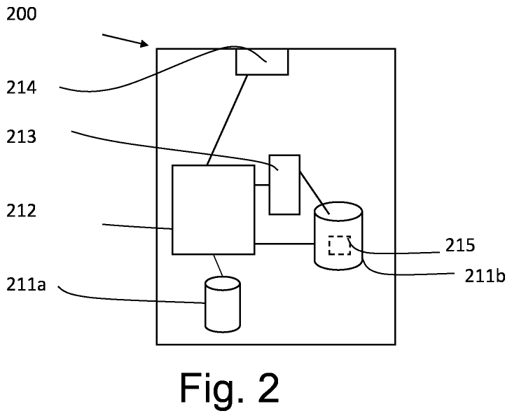

FIG. 2 illustrates an example of a control apparatus 200 for controlling a function of the 5GRAN or the 5GC as illustrated on FIG. 1. The control apparatus may comprise at least one random access memory (RAM) 211a, at least on read only memory (ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The software code 215 may be stored in the ROM 211b. The control apparatus 200 may be interconnected with another control apparatus 200 controlling another function of the 5GRAN or the 5GC. In some embodiments, each function of the 5GRAN or the 5GC comprises a control apparatus 200. In alternative embodiments, two or more functions of the 5GRAN or the 5GC may share a control apparatus.

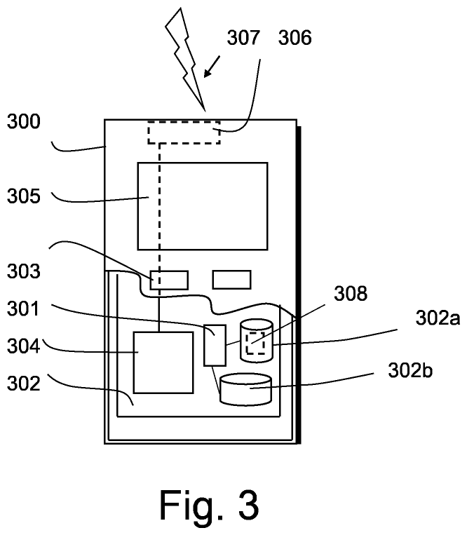

FIG. 3 illustrates an example of a terminal 300, such as the terminal illustrated on FIG. 1. The terminal 300 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, an Internet of things (IoT) type communication device or any combinations of these or the like. The terminal 300 may provide, for example, communication of data for carrying communications. The communications may be one or more of voice, electronic mail (email), text message, multimedia, data, machine data and so on.

The terminal 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The terminal 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302b and the ROM 302a. The at least one processor 301 may be configured to execute an appropriate software code 308. The software code 308 may for example allow to perform one or more of the present aspects. The software code 308 may be stored in the ROM 302a.

The processor, storage and other relevant control apparatus can be provided on an appropriate circuit board and/or in chipsets. This feature is denoted by reference 304. The device may optionally have a user interface such as key pad 305, touch sensitive screen or pad, combinations thereof or the like. Optionally one or more of a display, a speaker and a microphone may be provided depending on the type of the device.

Conditional Handover (CHO) has been introduced in 3GPP Rel. 16 to ensure robustness of the handover procedure.

In CHO the serving cell prepares multiple target cells and provides the related conditional reconfigurations along with CHO execution conditions to the UE. This is done to ensure that the radio conditions are still adequate for the UE to receive the reconfiguration. After receiving the CHO configuration, the UE evaluates the CHO execution conditions and initiates the handover to a specific target cell once its corresponding CHO execution condition is met.

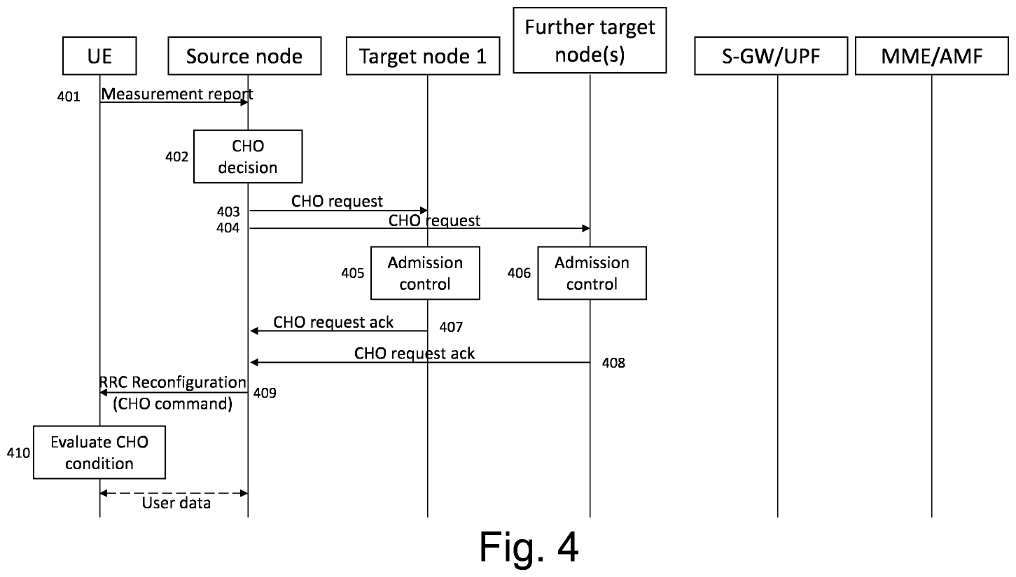

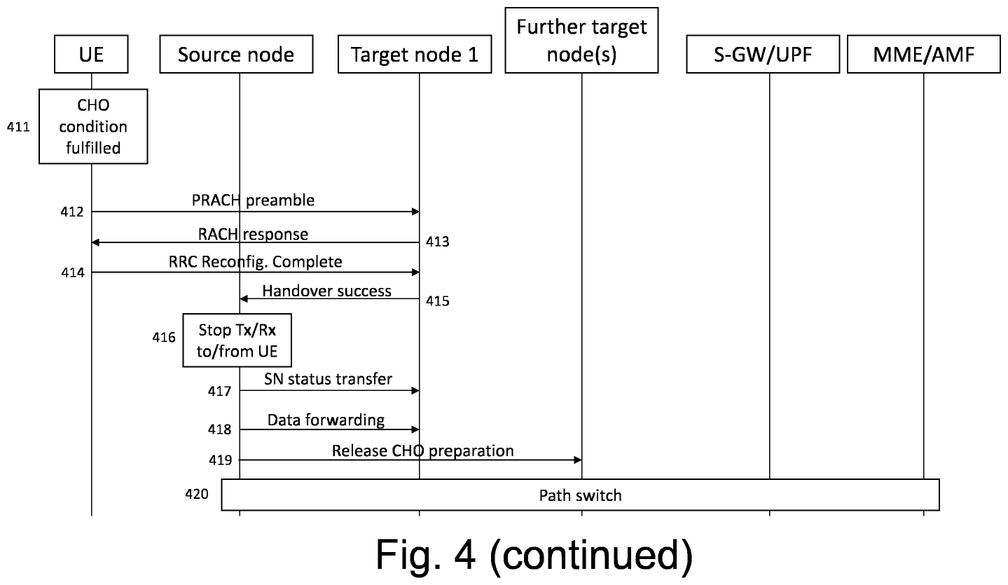

Reference is made to FIG. 4, which shows an example CHO procedure.

At step 400, a configured event condition holds and this triggers the UE to send a measurement report to the serving cell. For example, the UE may determine that a received signal strength from the source node is below a threshold value for a certain amount of time, or that a received signal strength of a neighbouring cell is above a threshold value for a certain amount of time.

Based on the report, the source node may prepare one or more target cells for the handover, as shown in steps 402 to 408.

In step 402, the source node determines whether CHO is to be performed. If the source node determines that CHO is to be performed, then at step 403 and 404 the source node sends a CHO request to one or more target nodes. At step 405 and 406, the one or more target nodes perform admission control, and at steps 407 and 408 send a CHO request acknowledgement back to the source node.

At step 409 the source node sends an RRC Reconfiguration (CHO command) to the UE. At step 410 the UE evaluates the CHO execution conditions and accesses the target node once one of the conditions is fulfilled and exchanges user data.

Handover is shown in steps 411 to 414 of FIG. 4. At step 411, the UE determines that a conditional handover condition for target node 1 is fulfilled. At step 412 the UE sends a PRACH preamble to the target node, which sends a RACH response at step 413. At step 14, the UE completes the handover execution to the target node, for example by sending an RRC Reconfiguration Complete to the target node.

When the target node receives the RRC Reconfiguration Complete message, at step 15 the target node sends to the source node “Handover Success” indication. The reception of “Handover Success” indication triggers:

the source node to stop transmissions to the UE and starts data forwarding the user plane packets to target node (steps 416 to 418); and the source initiates the release of the CHO preparations in other target nodes/cells (which are no longer needed) (step 419).

After SN status transfer and data forwarding has been sent and CHO preparations released, path switching for the UE is completed at step 420.

In some cases, for example at higher frequencies, cell changes (usually called “handovers” in the connected mode) may not always a result of linear UE movement along a trajectory. UEs which are not moving at all (or only slowly) may also experience handover as caused by:
Moving larger obstacles (e.g. cars) towards or away from the UE may temporally block the radio propagation from/to the serving cell with small wavelength and thus make a handover necessary;
Similarly, smaller obstacles in the vicinity of the UE may also block any transmission into a certain direction (e.g., the hand of a person holding the UE); or
When narrow beams are used for transmission also at the UE side, rotating the UE may also cause sudden drop in directive gain and lead to handovers (in particular if the spherical coverage is not 100%).

This can further be a problem in case of Reduced Capability (RedCap) UEs who are expected to be static (or have limited mobility).

According to 3GPP Rel.16 CHO process, the UE releases all the stored CHO configurations (corresponding to prepared candidate target cells) upon the handover execution to the target cell for which the CHO execution condition is met.

Thus, after performing CHO, the preparation of the (new) targets needs to take place again thus requiring:
1. Release of the prepared candidate target cells by the source node upon the handover is executed to target cells;
2. Preparation of the new candidate target cells by the new serving/source cell (i.e., which was serving as candidate target cell in the previous CHO); and
3. Transmission of a new RRC Configuration message to the UE containing the CHO configurations of the newly prepared candidate target cell by the new serving/source cell.

Re-initiating the CHO preparation from scratch may cause unnecessary signalling and possible delay in performing a subsequent handover.

To solve this issue, some solutions have been proposed where the UE can maintain the CHO configurations after the handover such that the UE can trigger another subsequent HO to another cell without restarting CHO preparation. However, such solutions may have drawbacks.

In an example, cell 1 (serving cell), prepares candidate target cell 2, 3 and cell 4. All candidate cells 2, 3 and 4 are aware that cell 1 is currently the serving cell. Once the corresponding CHO execution condition holds, UE may execute CHO to candidate target cell 2. Cell 2 informs Cell 1 about the cell change by means of Handover Success message. UE keeps the CHO configuration for cell 3 and 4.

However, if the CHO execution condition for cell 3 then holds while the UE is connected to cell 2, the UE may perform CHO execution to cell 3. Cell 3 may not know which cell (e.g. 1, 2 or 4) to inform about the cell change such that it can start data forwarding of the packets, if needed or trigger path switch. Cell 3 may blindly inform cell 1 or 2, or 4 of the handover, but this approach may not work as in most of the cases the wrong target cell would be contacted (67% of the cases in this example).

Therefore, in some examples the target cell may not be aware to which serving cell it should send the HO success message (step 415 in FIG. 4), since the target cell may not have been prepared by the last source cell. This may cause the source cell continuing transmission to the UE while the UE is waiting to be served by the new cell. In addition, the target cell might not be aware of the previous cell that UE has been connected to receive SN Status Transfer (step 417 in FIG. 4) and Data Forwarding (step 418 in FIG. 4).

Another possible issue that may arise with proposed solutions is that the candidate target cell may not know which serving cell to contact in case the candidate target cell wants to trigger the cancelation or modification of the CHO preparation.

For example, if candidate target e.g. cell 4, wants to release UE context (CHO preparation), cell 4 may not know which serving cell to contact (e.g. cell 1, 3, or 4) to cause the serving cell to release the CHO preparation of cell 4 from the UE side—for example by sending an RRC Reconfiguration message to the UE releasing the CHO preparation of cell 4.

Some examples of the present disclosure aim to address one or more of these issues.

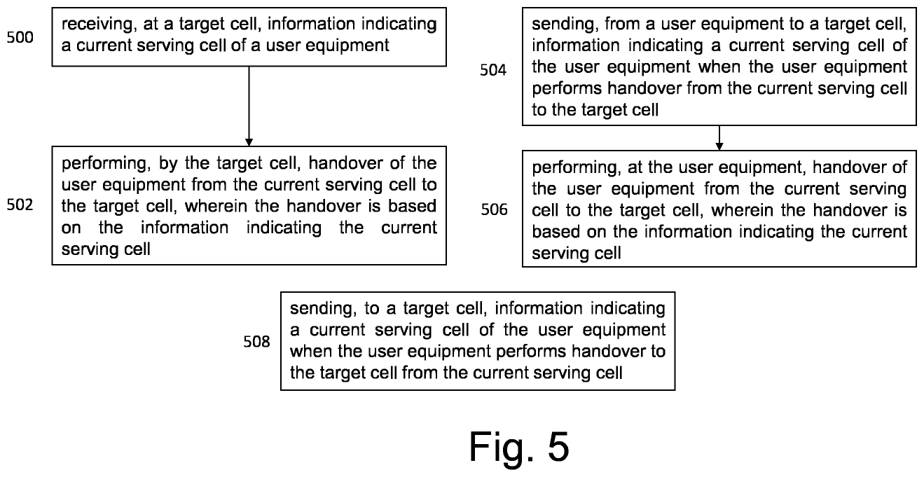

Reference is made to FIG. 5, which shows a method according to some examples.

In step 500, a method comprises receiving, at a target cell, information indicating a current serving cell of a user equipment.

In step 502, the method comprises performing, by the target cell, handover of the user equipment from the current serving cell to the target cell, wherein the handover is based on the information indicating the current serving cell.

In step 504, a method comprises sending, from a user equipment to a target cell, information indicating a current serving cell of the user equipment when the user equipment performs handover from the current serving cell to the target cell.

In step 506, the method comprises performing, at the user equipment, handover of the user equipment from the current serving cell to the target cell, wherein the handover is based on the information indicating the current serving cell.

In step 508, a method comprises sending, to a target cell, information indicating a current serving cell of the user equipment when the user equipment performs handover to the target cell from the current serving cell.

As used herein, the initial source cell is defined as being the serving cell that has initiated CHO preparation for the UE. That is to say, the initial source cell is the cell that transmits CHO request to the other cells.

In some examples, the UE may inform a target cell for which the CHO execution condition is met about the previous serving cell (source cell of handover). For example, the UE can inform the target cell during the CHO execution, e.g., random access procedure by means of lower layer (MAC) or higher layer signalling (RRC), or the UE can inform the target cell after the CHO execution is completed by means of lower layer or higher layer signalling.

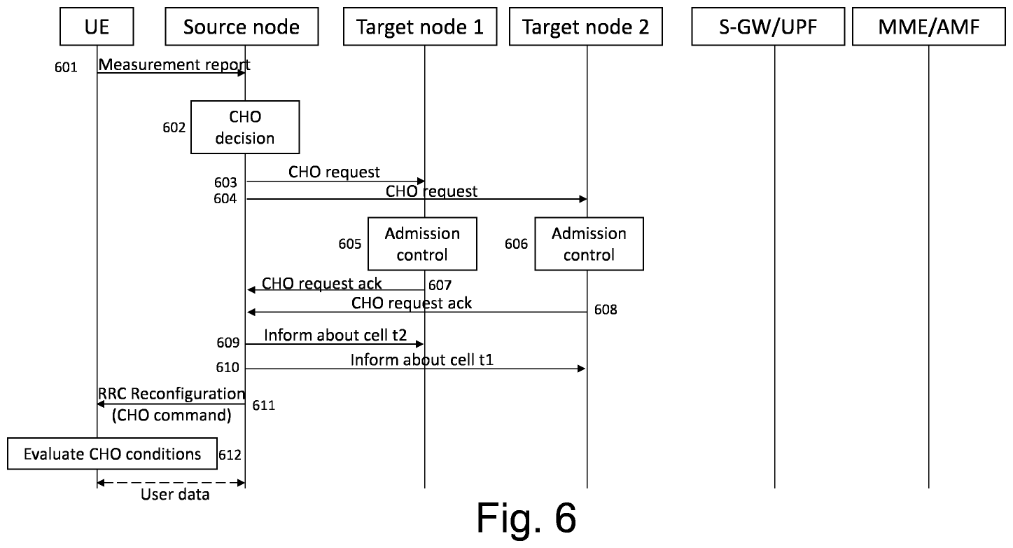

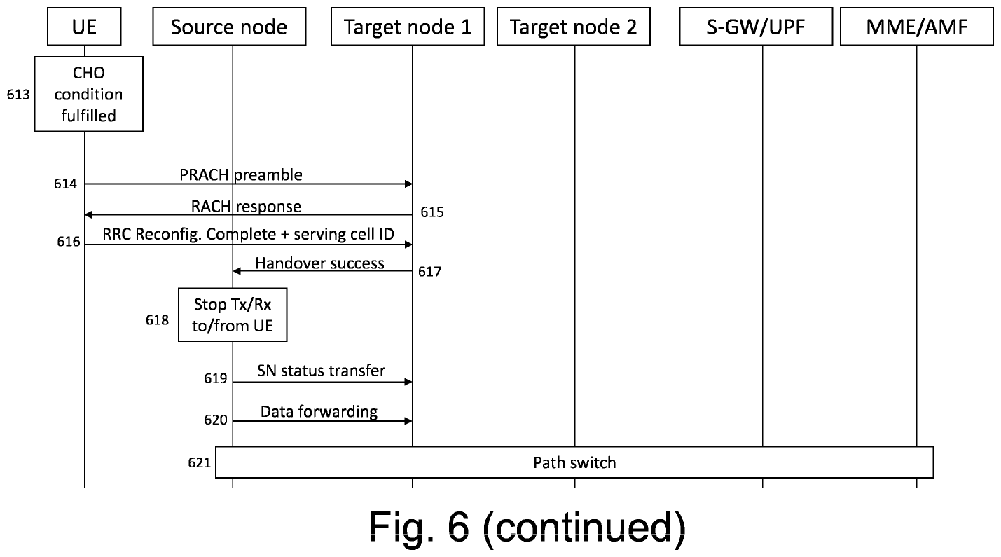

Reference is made to FIG. 6, which shows a CHO process according to some examples.

The process of FIG. 6 begins with steps 601-608, which corresponds to steps 401-408 described previously in FIG. 4. In brief, the source node prepares multiple targets nodes e.g., target node 1 (controlling target cell 1) and target node 2 (controlling target cell 2) based on the UE measurements.

In steps 609 and 610 the source node sends, to the target nodes, a message comprising information about the other prepared cells that UE is configured with for CHO.

In some examples, the message may enable the target nodes to deduce that the CHO configurations will be maintained after handover, either implicitly (by the message being received), or explicitly (for example, the content of the message indicating as such).

In step 611 the source node sends the RRC reconfiguration for CHO to the UE.

In step 612, the UE evaluates the CHO conditions, while it is being served by the source node and exchanging user data with the source node.

In steps 613-615, once the condition for a CHO target cell is fulfilled, the UE performs RACH signalling to the target cell for which the CHO condition is met.

Once RACH is completed, in step 616 the UE sends a message, such as the RRC Reconfiguration Complete (HO Complete) message, to the target node. The message comprises the information about the current serving (i.e., source) cell.

Thus, the new serving cell is informed of which cell to send the HO success message for initiating the data forwarding process.

In step 617, target node 1 sends a message indicating successful handover (e.g. HO Success) to the source node. The target node may be aware about the source node, since the CHO Request (i.e., message 603) has been sent by the source node.

Steps 618-620 follow steps 416 to 418 of FIG. 4.

After SN status transfer and data forwarding has been sent and CHO preparations released, path switching for the UE is completed at step 621.

Some examples may provide the full RRC Configuration to the UE in step 611. In other examples the UE may store the RRC Configuration of the initial source cell and apply the delta configuration of the preparation candidate cell on top of this.

It should be noted that in case the involved cells are handled by the same Central Unit the security key may not be changed.

In some examples, the new serving cell (the target cell for which the CHO execution condition is met) or the source cell of the CHO may inform the other prepared candidate target cells about the serving cell change. In some examples, this may comprise informing the other prepared candidate target cells of a cell identity (Physical Cell Identify (PCI) or NR Global Cell Identity (NCGI) of the new serving cell.

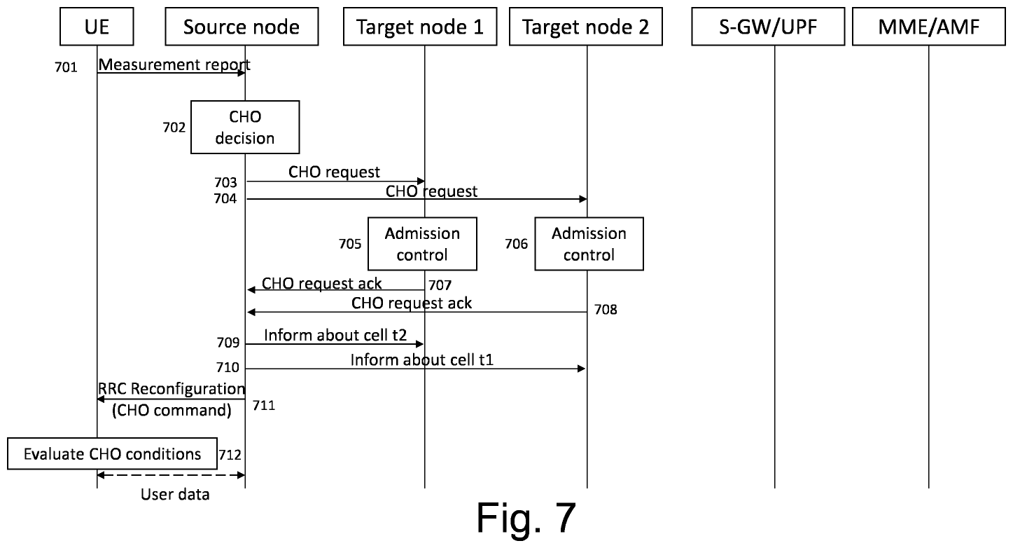

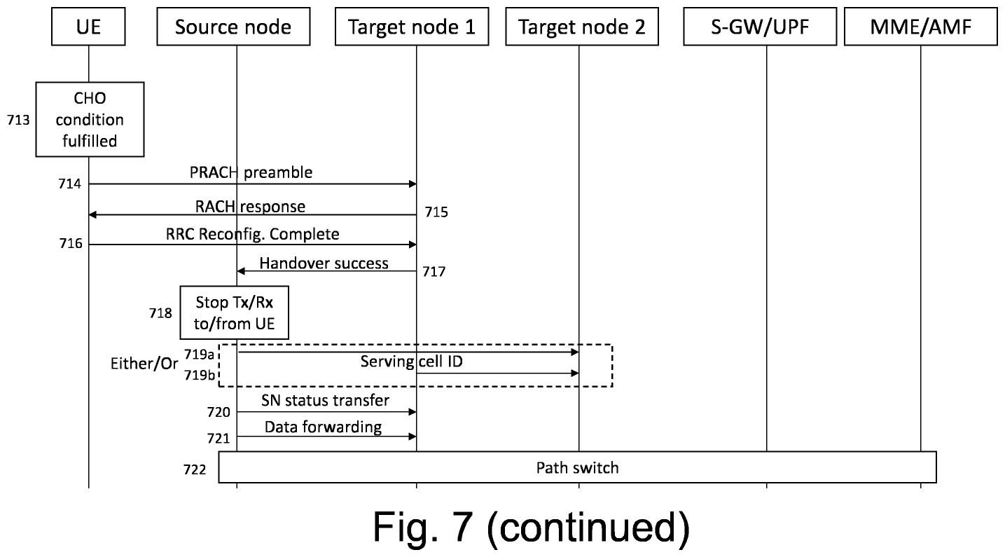

Reference is made to FIG. 7, which shows a CHO process according to some examples. In this example, the UE target cells may be informed about the cell change via interactions with the source cell.

The process of FIG. 7 begins with steps 701-715, which corresponds to steps 601-615 to the FIG. 6.

In step 716, the UE provides to the target node the RRC Reconfiguration Complete (HO Complete).

In step 717, the target node sends a message indicating successful handover (e.g. HO Success) to the source node. The target node may be aware about the source node, since the CHO Request (i.e., message 703) has been sent by the source node.

In step 718, the source node stops transmission to or reception from the UE.

In step 719a, the source node may inform all the other target candidate cells except the one that the UE has been handed over to about the serving cell change. Thus, the target cells will be aware about the cell identity (PCI or NGCI) of new serving node.

Alternatively, in step 719b, the target node may inform all the other potential target cells about the serving cell change of the UE. Thus, the target cells will be aware about the cell identify of the new serving node.

Steps 720 to 722 follow steps 619 to 621 of FIG. 6.

Some examples may provide the full RRC Configuration to the UE in step 711. In other examples the UE may store the RRC Configuration of the initial source cell and apply the delta configuration of the preparation candidate cell on top of this.

It should be noted that in case the involved cells are handled by the same Central Unit the security key may not be changed.

In some examples, the initial source cell may inform the prepared cells every time about the serving cell change upon the reception of the HO Success message. In these examples, the target cell for which the CHO execution condition is met may send the HO Success message to the initial source cell. Thus, the initial source cell can act as anchor point to relay the HO success to prepared cells, and also HO cancel request from a candidate target cell to the right serving cell.

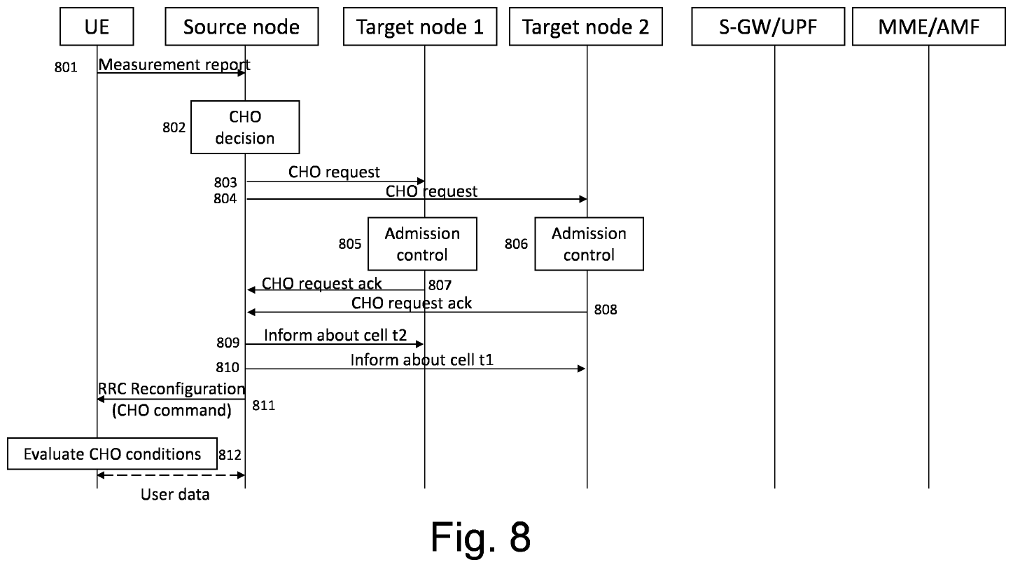

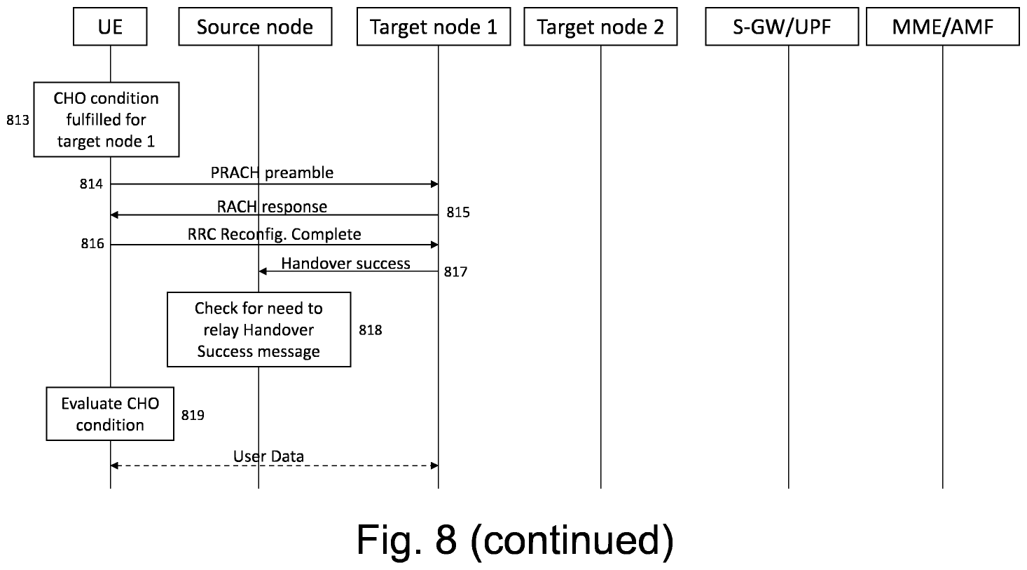

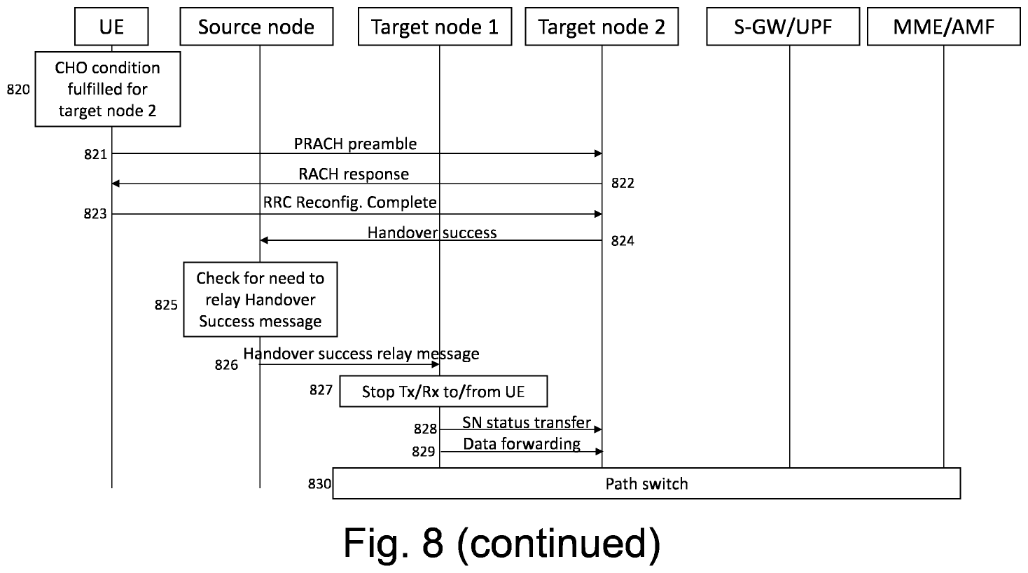

Reference is made to FIG. 8, which shows a CHO process according to some examples. In this example, the initial source cell acts as an anchor for relaying HO success to the serving cell in each handover process by maintaining a table of the latest serving cell of the UE.

The process of FIG. 8 begins with steps 801-817, which corresponds to steps 701-717 of FIG. 7.

In step 818 the source node, which has prepared the CHO, determines whether the source node needs to relay an indication of handover success to other target nodes. For example, the source node may maintain a table of the latest serving cell of the UE and use this table in the determination at step 818. In this example, the latest serving cell is the source node, thus requiring no HO Success relay message.

The UE is then connected to Target Node 1 and may decide to perform CHO to Target Node 2, for example using steps 819 to 823.

In step 820, the UE evaluates the CHO conditions, while it is being served by target node 1 and exchanging user data with target node 1.

In steps 821-822, once the condition for a CHO target cell is fulfilled, the UE performs RACH signalling to the target cell for which the CHO condition is met, which in this example is target node 2.

Once RACH is completed, in step 823 the UE sends a message, such as the RRC Reconfiguration Complete (HO Complete) message, to the target node.

In step 824, the Target node 2 provides the HO Success message to the source node that requested the preparation of CHO configurations.

In step 825 the source node, which prepared the CHO and maintains a table of the latest serving cell of the UE (from the latest received HO Success) identifies that the latest serving cell is a cell 1 controlled by Target node 1, and therefore determines that an indication of the current serving cell needs to be sent to target node 1, for example in a handover success relay message.

In step 826, in response to the identification and determination at step 825, the source node will send a HO Success relay message to Target node 1.

The HO Success relay message may include information about the new serving cell of UE (i.e. the target cell for which the UE has performed random access in step 821-824) such that SN status transfer and data forwarding may be initiated from the current serving cell to the target cell.

At step 827, target node 1 stops transmission to and reception from the UE.

Steps 828 to 830 follow steps 720 to 722 of FIG. 7.

Some examples may provide the full RRC Configuration to the UE in step 811. In other alternative implementations the UE may store the RRC Configuration of the initial source cell and apply the delta configuration on top of this.

It should be noted that in case the involved cells are handled by the same Central Unit the security key is not changed which simplifies the procedure.

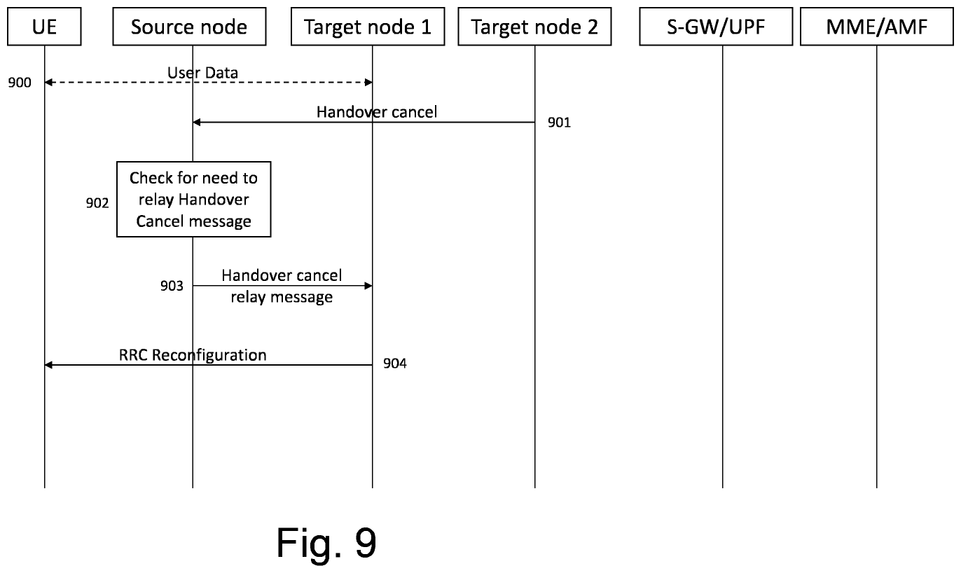

In some examples, one of the target cells may decide to cancel the HO preparation of a CHO. The initial source cell may act as an anchor point to relay this message to the other target nodes. An example process for relaying the cancellation of HO preparation is shown in FIG. 9.

In the example of FIG. 9, there is an initial source node, target node 1 which is the current source node, and target cell 2 which is a candidate target node for the UE. Initially, as shown at 900, the UE exchanges user data with target node 1.

At step 901, the target node 2 sends a HO cancel message to the initial source node.

At step 902, the initial source node checks if it has to notify the network node controlling the current serving cell about the cancellation of HO in target node 2. In this case, the initial source node determines that target node 1 is the current source node, and needs notifying of the HO cancellation in target node 2.

At step 903, the initial source node sends, to the target node 1, information about the HO cancellation in target node 2. The information may comprise information about target node 2 PCI ID.

In some examples, if the target node has the information about the other prepared cells, the target node can additionally or alternatively send HO cancel message to the other prepared cells.

At step 904, in response to receiving the information about the HO cancellation in target node 2, the target node 1 sends an RRC Reconfiguration message to the UE. The RRC Reconfiguration may cause the UE to remove target node 2 as a possible option for conditional handover.

Thus, in some examples, a target node may be informed of what cell is currently serving a UE (i.e. the current serving node) after a handover operation. The target node can be informed by the initial source node, the new serving node, or the UE.

Therefore, in some examples, when the UE performs handover to the target cell, the target cell knows which serving cell it should send the HO success message, thereby facilitating the handover and allowing SN Status Transfer and Data Forwarding to be performed properly. Furthermore, examples may enable a target cell to identify which serving cell to contact in case the target cell wants to trigger the cancelation or modification of the CHO preparation.

In some examples, there is provided an apparatus comprising means for receiving, at a target cell, information indicating a current serving cell of a user equipment; and performing, by the target cell, handover of the user equipment from the current serving cell to the target cell, wherein the handover is based on the information indicating the current serving cell.

In some examples, the apparatus comprises at least one processor and at least one memory including a computer program code, the at least one memory and computer program code configured to, with the at least one processor, cause the apparatus at least to: receive information indicating a current serving cell of a user equipment; and perform handover of the user equipment from the current serving cell to a target cell, wherein the handover is based on the information indicating the current serving cell.

In some examples, there is provided an apparatus comprising means for: sending, from a user equipment to a target cell, information indicating a current serving cell of the user equipment when the user equipment performs handover from the current serving cell to the target cell; and performing, at the user equipment, handover of the user equipment from the current serving cell to the target cell, wherein the handover is based on the information indicating the current serving cell.

In some examples, the apparatus comprises at least one processor and at least one memory including a computer program code, the at least one memory and computer program code configured to, with the at least one processor, cause the apparatus at least to: send, to a target cell, information indicating a current serving cell of a user equipment when the user equipment performs handover from the current serving cell to the target cell; and perform handover of the user equipment from the current serving cell to the target cell, wherein the handover is based on the information indicating the current serving cell.

In some examples, there is provided an apparatus comprising means for: sending, to a target cell, information indicating a current serving cell of the user equipment when the user equipment performs handover to the target cell from the current serving cell.

In some examples, the apparatus comprises at least one processor and at least one memory including a computer program code, the at least one memory and computer program code configured to, with the at least one processor, cause the apparatus at least to: send, to a target cell, information indicating a current serving cell of the user equipment when the user equipment performs handover to the target cell from the current serving cell.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst some embodiments have been described in relation to 5G networks, similar principles can be applied in relation to other networks and communication systems. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:

(a) hardware-only circuit implementations (such as implementations in only analog and/or digital circuitry) and

(b) combinations of hardware circuits and software, such as (as applicable):

(i) a combination of analog and/or digital hardware circuit(s) with software/firmware and

(ii) any portions of hardware processor(s) with software (including digital signal processor(s)), software, and memory(ies) that work together to cause an apparatus, such as a mobile phone or server, to perform various functions) and

(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process.

Complex and powerful software tools are available for converting a logic level design into a semiconductor circuit design ready to be etched and formed on a semiconductor substrate.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further embodiment comprising a combination of one or more embodiments with any of the other embodiments previously discussed.

1. An apparatus comprising:
at least one processor; and
at least one memory including a computer program code, the at least one memory and computer program code configured to, with the at least one processor, cause the apparatus to perform at least the following:
receiving, at a target cell, information indicating a current serving cell of a user equipment; and
performing, by the target cell, handover of the user equipment from the current serving cell to the target cell, wherein the handover is based on the information indicating the current serving cell.

2. The apparatus of claim 1, configured to:
receive, at the target cell from an initial source cell serving the user equipment, a conditional handover configuration for the user equipment;
wherein performing the handover is further based on the conditional handover configuration.

3. The apparatus of claim 2, configured to,
upon completion of the handover, send, to one or more further cells, information indicating that the target cell is the new current serving cell of the user equipment.

4. The apparatus of claim 1, wherein the information indicating the current serving cell of the user equipment is received from one of:
the user equipment during the handover of the user equipment from the current serving cell to the target cell;
the current serving cell during the handover of the user equipment from the current serving cell to the target cell; and
an initial source cell during the handover of the user equipment from the current serving cell to the target cell.

5. The apparatus of claim 1, wherein performing the handover based on the information indicating the current serving cell comprises:
receiving, from the current serving cell and based on the information indicating the current serving cell, status information associated with the user equipment and/or data buffered at the current serving cell for delivery to the user equipment.

6. An apparatus comprising:
at least one processor; and
at least one memory including a computer program code, the at least one memory and computer program code configured to, with the at least one processor, cause the apparatus to perform at least the following:
sending, from a user equipment to a target cell, information indicating a current serving cell of the user equipment when the user equipment performs handover from the current serving cell to the target cell; and
performing, at the user equipment, handover of the user equipment from the current serving cell to the target cell, wherein the handover is based on the information indicating the current serving cell.

7. The apparatus of claim 6, configured to
receive, at the user equipment from an initial source cell serving the user equipment, at least one conditional handover configuration for the user equipment;
wherein performing the handover is further based on the conditional handover configuration.

8. The apparatus of claim 7, wherein the information indicating the current serving cell of the user equipment is comprised in a radio resource control reconfiguration complete message sent to the target cell when performing the handover.

9. The apparatus of claim 6, configured to perform the following:
storing a radio resource control configuration of an initial source cell; and
applying a change in radio resource control configuration on top of the radio resource control configuration of the initial source cell when handover of the user equipment is performed.

10. The apparatus of claim 7, configured to perform the following:
receiving, from the current serving cell, a message comprising an indication that one or more further target cells are no longer available for conditional handover of the user equipment; and
updating a conditional handover configuration of the user equipment based on the received message.

11. An apparatus comprising:
at least one processor; and
at least one memory including a computer program code, the at least one memory and computer program code configured to, with the at least one processor, cause the apparatus to perform at least the following:
sending, to a target cell, information indicating a current serving cell of the user equipment when the user equipment performs handover to the target cell from the current serving cell.

12. The apparatus of claim 11, wherein the apparatus comprises the current serving cell, and wherein the apparatus is further configured to:
receive, from the target cell, an indication that handover has been performed for the user equipment to the target cell; and
responsive to receiving the indication, send, to the target cell, status information associated with the user equipment and/or data buffered at the current serving cell for delivery to the user equipment.

13. The apparatus of claim 12, configured to perform the following:
receiving, from an initial source cell, information indicating that the one or more further target cells are no longer available for conditional handover of the user equipment; and
sending, to the user equipment, a message comprising an indication that the one or more further target cells are no longer available for conditional handover of the user equipment.

14. The apparatus of claim 12, wherein the apparatus comprises an initial source cell; and wherein the apparatus is further configured to
send, to the target cell, a conditional handover configuration for the user equipment.

15. The apparatus of claim 14, wherein the apparatus is further configured to perform the following:
receiving, from the current serving cell, information indicating that the user equipment has been handed over to the current serving cell;
storing, at the initial source cell and based on the received information, the information identifying the current serving cell of the user equipment; and
sending, to the target cell, the information indicating the current serving cell of the user equipment.

16. The apparatus of claim 14, further configured to perform the following:
receiving, from one or more further target cells, information indicating that the one or more further target cells are no longer available for conditional handover of the user equipment; and
sending, to the current serving cell, a message comprising an indication that one or more further target cells are no longer available for conditional handover of the user equipment.
